(19) United States
(12) Patent Application Publication
(10) Pub. No.: US 2020/0032139 A1
(43) Pub. Date: Jan. 30, 2020

(54) COMPOSITE PARTICLE

(71) Applicant: Sumitomo Chemical Company Limited, Tokyo (JP)

(72) Inventors: Jonathan Behrendt, Bedford (GB); Florence Bourcet, Cambridge (GB)

(73) Assignee: Sumitomo Chemical Company Limited, Tokyo (JP)

(21) Appl. No.: 16/338,287

(22) PCT Filed: Sep. 29, 2017
(86) PCT No.: PCT/GB2017/052924

§ 371 Date: Mar. 29, 2019

(30) Foreign Application Priority Data
Sep. 30, 2016 (GB) 1616714.0

(51) Int. Cl. C09K 11/06; C08G 77/04; C08G 61/12

(52) U.S. Cl. CPC C09K 11/06; C08G 77/04; C08G 61/12; B82Y 30/00; C08G 2261/522; C08G 2261/3142; C08G 2261/1426

(57) ABSTRACT

A composite comprising silica and a light- emitting polymer comprising a backbone and polar groups pendant from the backbone.

### FIELD OF THE INVENTION

The present invention relates to composite light-emitting particles and the use thereof as a luminescent marker. The present invention further relates to a method of preparing said composite particles.

### BACKGROUND OF THE INVENTION

Silica nanoparticles form highly stable suspensions in aqueous solvents, for example aqueous biological buffers, even at very high solid contents, due to their hydrophilic nature. Nanoparticles of silica and a light-emitting material have been disclosed as labelling or detection reagents.

Nanoscale Res. Lett., 2011, vol. 6, p 328 discloses entrapment of a small molecule in a silica matrix.

Langmuir, 1992, vol. 8, pp 2921-2931 discloses coupling of a dye to a silane coupling agent which is then incorporated into a silica sphere.

J. Mater. Chem., 2013, vol. 1, pp 3297-3304, Behrendt et al. describes silica-LEP nanoparticles where the LEP is covalently bound to the silica. The light emitting polymer has alkoxysilane groups pendant from the polymer backbone which react with the silica monomer during formation of the nanoparticles.

Nanoscale, 2013, vol. 5, pp 8593-8601, Geng et al. describes silica-conjugated polymer (CP) nanoparticles wherein the LEP has pendant non-polar alkyl side chains and where the nanoparticles have a “SiO₂@CP@SiO₂” structure.

Chem. Mater., 2014, vol. 26, pp 1874-1880, Geng et al. discloses poly(9,9-dihexylfluorene-alt-2,1,3-benzothiadiazole) (PFBT) loaded nanoparticles.

It is an object of the invention to provide structurally stable light-emitting particles.

It is a yet further object of the invention to provide light-emitting particles having high colloidal stability.

It is a yet further object of the invention to provide a simple synthesis of said light-emitting particles.

### SUMMARY OF THE INVENTION

The present inventors have found that the combination of a silica polymer and a light-emitting polymer substituted with polar groups can provide stable light-emitting particles with good colloid forming properties.

Accordingly, in a first aspect of the invention provides a composite particle comprising a silica polymer and a light-emitting polymer comprising a backbone and polar groups pendant from the backbone.

In a second aspect the invention provides a colloidal suspension comprising composite particles according to the first aspect of the invention suspended in a liquid.

In a third aspect the invention provides a process for preparing composite particles according to the first aspect of the invention, comprising formation of the silica polymer by polymerisation of a silica monomer in the presence of the light emitting polymer

The present inventors have found that the colloidal stability of particles comprising silica, particularly colloidal stability in aqueous salt solutions, may be enhanced by providing polyether groups on the surface of the particles.

Accordingly, in a fourth aspect the invention provides particles comprising of silica having polyether groups on a surface thereof.

In a fifth aspect the invention provides a colloid comprising a liquid and particles of the fourth aspect. The liquid is preferably a protic liquid, optionally water or an alcohol.

The liquid may comprise one or more salts dissolved therein. The liquid may be a buffer solution.

In a sixth aspect the invention provides a method of forming particles according to the fourth aspect, the method comprising the step of reacting a reactive group of a compound comprising the reactive group and a polyether group with the particles to covalently bind the polyether group to the surface of the particles.

The reaction at the surface of the particles may be a reaction between the reactive group and silica at the surface or may be a reaction between another reactive group, optionally an amine, at the silica surface and the reactive group of the compound.

The particle of the fourth aspect may comprise or consist of silica.

The particle of the fourth aspect may be comprise silica and at least one light-emitting material. The light-emitting material may be polymeric or non-polymeric. The light-emitting material may or may not be covalently bound to the particle. The particle may be a composite particle according to the first aspect.

### DESCRIPTION OF THE DRAWINGS

The invention will now be described in more detail with reference to the drawings wherein:

FIG. 1 is a graph of mean number % vs. diameter (inn) for blue light emitting silica-LEP nanoparticles according to embodiments of the invention;

FIG. 2 is an absorption spectrum for blue light emitting silica-LEP nanoparticles according to embodiments of the invention;

FIG. 3 is a photoluminescence spectrum for blue light emitting silica-LEP nanoparticles according to embodiments of the invention;

FIG. 4 is a graph of size distributions of colloidal suspensions in methanol of composite particles that have not been surface-treated and composite particles that have been treated to form an amino group at the surface thereof;

FIG. 5 is a graph of size distributions of colloidal suspensions in water of composite particles that have not been surface-treated and composite particles that have been treated to form an amino group at the surface thereof;

FIG. 6 is a graph of size distributions of colloidal suspensions in phosphate buffered saline (pH 7.4) of composite particles that have not been surface-treated and composite particles that have been treated to form a polyethyleneglycol chain at a surface thereof;

FIG. 7 is a UV absorption spectrum of green light emitting composite nanoparticles according to an embodiment;

FIG. 8 is a photoluminescence spectrum of green light emitting composite nanoparticles according to an embodiment;

FIG. 9 is a graph of Z-average diameter of green light emitting composite nanoparticles according to an embodiment vs light-emitting polymer concentration;

FIG. 10 is a graph of Z-average diameter of green light emitting composite nanoparticles according to an embodiment vs base volume;

FIG. 11 is a graph of Z-average diameter of green light emitting composite nanoparticles according to an embodiment vs silicate volume; and

FIG. 12 is a graph of Z-average diameter of green light emitting composite nanoparticles according to an embodiment vs total dilution.

### DETAILED DESCRIPTION OF THE INVENTION

A first aspect of the invention provides a composite particle comprising a mixture of a silica polymer and a light-emitting polymer comprising a backbone and polar groups pendant from the backbone.

“Silica polymer” as used herein means a polymer comprising siloxane groups. The silica polymer may have a linear, branched or crosslinked backbone comprising or consisting of alternating Si and O atoms.

The silica polymer may form a matrix in which the light-emitting polymer is dispersed.

The light-emitting polymer and the silica polymer of the composite are not covalently bound to one another. Accordingly, there is no need for the silica polymer and/or the light-emitting polymer to be substituted with reactive groups for forming such covalent bonds during formation of the particles.

The light-emitting polymer may emit fluorescent light, phosphorescent light or a combination thereof.

The light-emitting polymer may be a homopolymer or may be a copolymer comprising two or more different repeat units.

The light-emitting polymer may comprise light-emitting groups in the polymer backbone, pendant from the polymer backbone or as end groups of the polymer backbone. In the case of a phosphorescent polymer, a phosphorescent metal complex, preferably a phosphorescent iridium complex, may be provided in the polymer backbone, pendant from the polymer backbone or as an end group of the polymer backbone.

The light-emitting polymer may have a non-conjugated backbone or may be a conjugated polymer. By “conjugated polymer” is meant a polymer comprising repeat units in the polymer backbone that are directly conjugated to adjacent repeat units.

Conjugated light-emitting polymers include, without limitation, polymers comprising one or more of arylene, heteroarylene and vinylene groups conjugated to one another along the polymer backbone.

The light-emitting polymer may have a linear, branched or crosslinked backbone.

The light-emitting polymer may comprise one or more repeat units in the backbone of the polymer substituted with at least one polar group. The one or more polar groups may be the only substituents of said repeat units, or said repeat units may be further substituted with one or more non-polar groups, optionally one or more C₁₋₄₀ hydrocarbyl groups. The repeat unit or repeat units substituted with one or more polar groups may be the only repeat units of the polymer or the polymer may comprise one or more further co-repeat units wherein the or each co-repeat unit is unsubstituted or is substituted with non-polar groups, optionally one or more C₁₋₄₀ hydrocarbyl groups.

C₁₋₄₀ hydrocarbyl groups as described herein include, without limitation, C₁₋₂₀ alkyl, unsubstituted phenyl and phenyl substituted with one or more C₁₋₂₀ alkyl groups.

As used herein “polar groups” may refer to one more groups which render the light-emitting polymer with a solubility of at least 0.0005 mg/ml in an alcoholic solvent, preferably at least 0.001, 0.01, 0.1, 1, 5 or 10 mg/ml. The solubility is measured at 25° C. Preferably, the alcoholic solvent is a C₁₋₁₀ alcohol, more preferably methanol.

Polar groups are preferably groups capable of forming hydrogen bonds or ionic groups.

In one embodiment of the first aspect of the invention, the light-emitting polymer comprises polar groups of formula —O(R³O)_{q}—R⁴ wherein R³ in each occurrence is a C₁₋₁₀ alkylene group, optionally a C₁₋₅ alkylene group, wherein one or more non-adjacent, non-terminal C atoms of the alkylene group may be replaced with O, R⁴ is H or C₁₋₅ alkyl, and q is at least 1, optionally 1-10. Preferably, q is at least 2. More preferably, q is 2 to 5. The value of q may be the same in all the polar groups of formula —O(R³O)_{q}—R⁴.

The value of q may differ between polar groups of the same polymer.

By “C₁₋₅ alkylene group” as used herein with respect to R³ is meant a group of formula —(CH₂)_{f}— wherein f is from 1-5.

Preferably, the light-emitting polymer comprises polar groups of formula —O(CH₂CH₂O)_{q}A⁴ wherein q is at least 1, optionally 1-10 and R⁴ is a C₁₋₅ alkyl group, preferably methyl. Preferably, q is at least 2. More preferably, q is 2 to 5, most preferably q is 3.

In one embodiment of the first aspect of the invention, the light-emitting polymer comprises polar groups of formula —N(R⁵)₂, wherein R⁵ is H or C₁₋₁₂ hydrocarbyl. Preferably, each R⁵ is a C₁₋₁₂ hydrocarbyl.

In one embodiment of the first aspect of the invention, the light-emitting polymer comprises polar groups which are ionic groups which may be anionic, cationic or zwitterionic. Preferably the ionic group is an anionic group.

Exemplary anionic group are —COO⁻, a sulfonate group; hydroxide; sulfate; phosphate; phosphinate; or phosphonate.

An exemplary cationic group is —N(R⁵)₃⁺ wherein R⁵ in each occurrence is H or C₁₋₁₂ hydrocarbyl. Preferably, each R⁵ is a C₁₋₁₂ hydrocarbyl.

A light-emitting polymer comprising cationic or anionic groups comprises counterions to balance the charge of these ionic groups.

An anionic or cationic group and counterion may have the same valency, with a counterion balancing the charge of each anionic or cationic group.

The anionic or cationic group may be monovalent or polyvalent. Preferably, the anionic and cationic groups are monovalent.

The light-emitting polymer may comprise a plurality of anionic or cationic polar groups wherein the charge of two or more anionic or cationic groups is balanced by a single counterion. Optionally, the polar groups comprise anionic or cationic groups comprising di- or trivalent counterions.

The counterion is optionally a cation, optionally a metal cation, optionally Li⁺, Na⁺, K⁺, Cs⁺, preferably Cs⁺, or an organic cation, optionally ammonium, such as tetraalkylammonium, ethylmethyl imidazolium or pyridinium.

The counterion is optionally an anion, optionally a halide; a sulfonate group, optionally mesylate or tosylate; hydroxide; carboxylate; sulfate; phosphate; phosphinate; phosphonate; or borate.

In one embodiment of the first aspect of the invention, the light-emitting polymer comprises polar groups selected from groups of formula —O(R³O)_{q}—R⁴, groups of formula —N(R⁵)₂, groups of formula OR⁴ and/or ionic groups. Preferably, the light-emitting polymer comprises polar groups selected from groups of formula —O(CH₂CH₂O)_{q}R⁴, groups of formula —N(R⁵)₂, and/or anionic groups of formula —COO⁻. Preferably, the polar groups are selected from the group consisting of groups of formula —O(R³O)_{q}—R⁴, groups of formula —N(R⁵)₂, and/or ionic groups. Preferably, the polar groups are selected from the group consisting of polyethylene glycol (PEG) groups of formula —O(CH₂CH₂O)_{q}R⁴, groups of formula —N(R⁵)₂, and/or anionic groups of formula —COO⁻. R³, R⁴, R⁵, and q are as described in relation to other embodiments of the invention.

Optionally, the backbone of the light-emitting polymer is a conjugated polymer.

Optionally, the backbone of the conjugated light-emitting polymer comprises repeat units of formula (I):

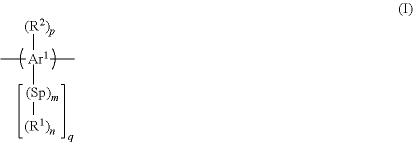

wherein Ar¹ is an arylene group or heteroarylene group; Sp is a spacer group; m is 0 or 1; R¹ independently in each occurrence is a polar group; n is 1 if m is 0 and n is at least 1, optionally 1, 2, 3 or 4, if in is 1; R² independently in each occurrence is a non-polar group; p is 0 or a positive integer; q is at least 1, optionally 1, 2, 3 or 4; and wherein Sp, R¹ and R² may independently in each occurrence be the same or different.

Preferably, m is 1 and n is 2-4, more preferably 4. Preferably p is 0.

Ar¹ of formula (I) is optionally a C₆₋₂₀ arylene group or a 5-20 membered heteroarylene group. Ar¹ is preferably a C₆₋₂₀ arylene group, optionally phenylene, fluorene, benzofluorene, phenanthrene, naphthalene or anthracene, more preferably fluorene or phenylene, most preferably fluorene.

Sp-(R¹)n may be a branched group, optionally a dendritic group, substituted with polar groups, optionally —NH₂ or —OH groups, for example polyethyleneimine.

Preferably, Sp is selected from:
C₁₋₂₀ alkylene or phenylene-C₁₋₂₀ alkylene wherein one or more non-adjacent C atoms may be replace with O, S, N or C═O;
a C₆₋₂₀ arylene or 5-20 membered heteroarylene, more preferably phenylene, which, in addition to the one or more substituents R¹, may be unsubstituted or substituted with one or more non-polar substituents, optionally one or more C₁₋₂₀ alkyl groups.

“alkylene” as used herein means a branched or linear divalent alkyl chain.

“non-terminal C atom” of an alkyl group as used herein means a C atom other than the methyl group at the end of an n-alkyl group or the methyl groups at the ends of a branched alkyl chain.

More preferably, Sp is selected from:
—C₁₋₂₀ alkylene wherein one or more non-adjacent C atoms may be replaced with O, S or CO; and
a C₆₋₂₀ arylene or a 5-20 membered heteroarylene, even more preferably phenylene, which may be unsubstituted or substituted with one or more non-polar substituents.
R¹ may be a polar group as described anywhere herein. Preferably, R¹ is:
a polyethylene glycol (PEG) group of formula —O(CH2CH₂O)_{q}R⁴ wherein q is at least 1, optionally 1-10 and R⁴ is a C₁₋₅ alkyl group, preferably methyl;
a group of formula —N(R⁵)₂, wherein R⁵ is H or C₁₋₁₂ hydrocarbyl; or
an anionic group of formula —COO⁻.

In the case where n is at least two, each R¹ may independently in each occurrence be the same or different. Preferably, each R¹ attached to a given Sp group is different.

In the case where p is a positive integer, optionally 1, 2, 3 or 4, the group R² may be selected from:
alkyl, optionally C₁₋₂₀ alkyl; and
aryl and heteroaryl groups that may be unsubstituted or substituted with one or more substituents, preferably phenyl substituted with one or more C₁₋₂₀ alkyl groups;
a linear or branched chain of aryl or heteroaryl groups, each of which groups may independently be substituted, for example a group of formula —(Ar³)ₛ wherein each Ar³ is independently an aryl or heteroaryl group and s is at least 2, preferably a branched or linear chain of phenyl groups each of which may be unsubstituted or substituted with one or more C₁₋₂₀ alkyl groups; and
a crosslinkable-group, for example a group comprising a double bond such and a vinyl or acrylate group, or a benzocyclobutane group.

Preferably, each R², where present, is independently selected from C₁₋₄₀ hydrocarbyl, and is more preferably selected from C₁₋₂₀ alkyl; unusubstituted phenyl; phenyl substituted with one or more C₁₋₂₀ alkyl groups; and a linear or branched chain of phenyl groups, wherein each phenyl may be unsubstituted or substituted with one or more substituents.

A polymer as described herein may comprise or consist of only one form of the repeating unit of formula (I) or may comprise or consist of two or more different repeat units of formula (I).

Optionally, the polymer comprising one or more repeat units of formula (I) is a copolymer comprising one or more co-repeat units.

If co-repeat units are present then the repeat units of formula (I) may form between 0.1-99 mol % of the repeat units of the polymer, optionally 50-99 mol % or 80-99 mol %.

Preferably, the repeat units of formula (I) form at least 50 mol% of the repeat units of the polymer, more preferably at least 60, 70, 80, 90, 95, 98 or 99 mol%. Most preferably the repeat units of the polymer consist of one or more repeat units of formula (I).

The or each repeat unit of the polymer may be selected to produce a desired colour of emission of the polymer.

A blue light-emitting polymer of a composite particle as described herein may have a photoluminescence spectrum with a peak of no more than 500 nm, preferably in the range of 400-500 nm, optionally 400-490 nm.

A green light-emitting polymer of a composite particle as described herein may have a photoluminescence spectrum with a peak of more than 500 run up to 580 nm, optionally more than 500 nm up to 540 nm.

A red light-emitting polymer of a composite particle as described herein may have a photoluminescence spectrum with a peak of no more than more than 580 nm up to 630 nm, optionally 585 nm up to 625 nm.

The photoluminescence spectrum of a light-emitting polymer as described herein may be measured in solution using apparatus C9920-02 supplied by Hamamatsu.

The backbone of a polymer comprising a unit of formula (I) may be non-conjugated or to conjugated.

The polymer is preferably a conjugated polymer comprising repeat units of formula (I) conjugated to one another and/or conjugated to aromatic or heteroaromatic groups of co-repeat units adjacent to the repeat units of formula (I). Exemplary conjugated polymers include polymers comprising arylenevinylene repeat units; arylene repeat units; heteroarylene repeat units; amine repeat units; and combinations thereof.

If present, the or each co-repeat unit may be unsubstituted or substituted with one or more non-polar substituents, optionally one or more repeat units comprising or consisting of one or more groups selected from C₆-₂₀ arylene groups and 5-20 membered heteroarylene groups, wherein each of said arylene or heteroarylene groups independently in each occurrence may be unsubstituted or substituted with one or more non-polar substituents..

Arylene repeat units of the polymer include, without limitation, fluorene, preferably a 2,7-linked fluorene; phenylene, preferably a 1,4-linked phenylene; naphthalene, anthracene, indenofluorene, phenanthrene and dihydrophenanthrene repeat units.

Arylene co-repeat units may be selected from repeat units of formulae (III)-(VI):

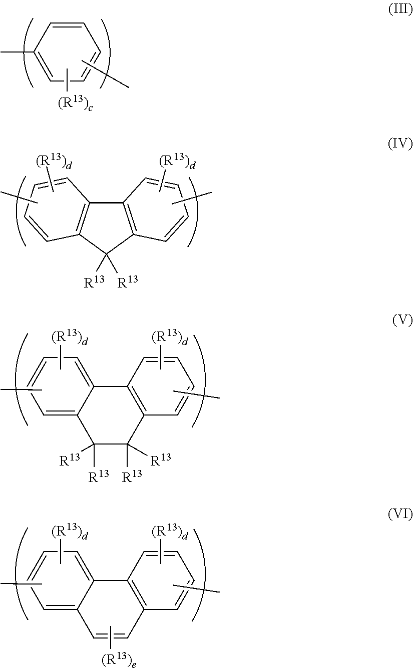

wherein R¹³ in each occurrence is independently a substituent; c is 0, 1, 2, 3 or 4, preferably 1 or 2; each d is independently 0, 1,2 or 3, preferably 0 or 1; and e is 0, 1 or 2, preferably 2.

Repeat units comprising or consisting of one or more unsubstituted or substituted 5-20 membered heteroarylene groups in the polymer backbone include, without limitation, thiophene repeat units, bithiophene repeat units, benzothiadiazole repeat units, and combinations thereof. Exemplary heteroarylene co-repeat units include repeat units of formulae (VII), (VIII) and (IX):

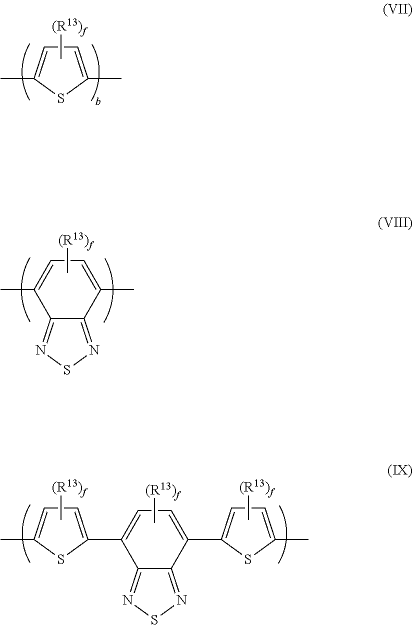

wherein R¹³ in each occurrence is independently a substituent and f is 0, 1 or 2.

R¹³ in each occurrence may independently be a group comprising or consisting of a polar group, optionally a polar substituent -(Sp)ₘ-(R¹)ₙ, or a non-polar substituent R² wherein Sp, m, R¹ and R² are as described with reference to Formula (I).

Arylene repeat units or heteroarylene repeat units substituted with one or more polar groups, optionally repeat units of formulae (III)-(IX) substituted with one groups of formula -(Sp)ₘ-(R¹)ₙ, are repeat units of formula (I).

Arylene repeat units or heteroarylene repeat units, optionally repeat units of formulae (III)-(IX), which are unsubstituted or substituted only with one or more non-polar groups, are co-repeat units of the polymer.

Amine repeat units of the polymer may have formula (XII):

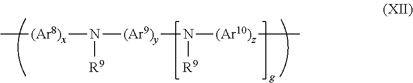

wherein Ar⁸, Ar⁹ and Ar¹⁰ in each occurrence are independently selected from substituted or unsubstituted aryl or heteroaryl, g is 0, 1 or 2, preferably 0 or 1, R¹³ independently in each occurrence is a substituent, and x, y and z are each independently 1,2 or 3.

R⁹, which may be the same or different in each occurrence when g is 1 or 2, is preferably selected from the group consisting of alkyl, optionally C₁₋₂₀ alkyl, Ar¹¹ and a branched or linear chain of Ar¹¹ groups wherein Ar¹¹ in each occurrence is independently substituted or unsubstituted aryl or heteroaryl.

Any two aromatic or heteroaromatic groups selected from Ar⁸, Ar⁹, and, if present, Ar¹⁰ and Ar¹¹ that are directly bound to the same N atom may be linked by a direct bond or a divalent linking atom or group. Preferred divalent linking atoms and groups include O, S; substituted N; and substituted C.

Ar⁸ and Ar¹⁰ are preferably C₆₋₂₀ aryl, more preferably phenyl, that may be unsubstituted or substituted with one or more substituents.

In the case where g=0, Ar⁹ is preferably C₆₋₂₀ aryl, more preferably phenyl, that may be unsubstituted or substituted with one or more substituents.

In the case where g=1, Ar⁹ is preferably C₆₋₂₀ aryl, more preferably phenyl or a polycyclic aromatic group, for example naphthalene, perylene, anthracene or fluorene, that may be unsubstituted or substituted with one or more substituents.

R⁹ is preferably Ar¹⁰ or a branched or linear chain of Ar¹¹ groups. Ar¹¹ in each occurrence is preferably phenyl that may be unsubstituted or substituted with one or more substituents.

Exemplary groups R⁹ include the following, each of which may be unsubstituted or substituted with one or more substituents, and wherein * represents a point of attachment to N:

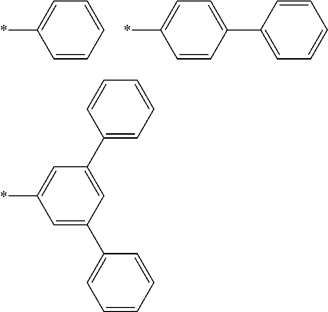

x, y and z are preferably each 1.

Ar⁸, Ar⁹, and, if present, Ar¹⁰ and Ar¹¹ are each independently unsubstituted or substituted with one or more, optionally 1, 2, 3 or 4, substituents.

Substituents may independently be a group comprising or consisting of a polar group, optionally a polar substituent -(Sp)ₘ-(R¹)ₙ, or a non-polar substituent R² wherein Sp, m, R¹ and R² are as described with reference to Formula (I).

Preferred substituents of Ar⁸, Ar⁹, and, if present, Ar¹⁰ and Ar¹¹ are C₁₋₄₀ hydrocarbyl, preferably C₁₋₂₀alkyl.

Preferred repeat units of formula (XII) include unsubstituted or substituted units of formulae (XII-1), (XII-2) and (XII-3):

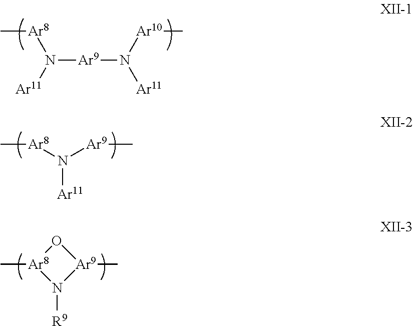

Preferably, a polymer comprising a repeat unit of formula (XII) further comprises one or more arylene repeat units, optionally one or more arylene repeat units selected from formulae (III)-(IX). Optionally, 0.1-50 mol % of a light-emitting polymer are one or more repeat units of formula (XII). Optionally, the repeat units of a light-emitting polymer comprise or consist of one or more repeat units of formula (XII) and one or more arylene repeat units, optionally one or more repeat units of formulae (III)-(IX).

In the case of a phosphorescent conjugated polymer a phosphorescent group, preferably a metal complex, more preferably an iridium complex, may be provided in the main chain, in a side group and/or as an end group of the polymer. An exemplary conjugating repeat unit comprising an iridium complex has formula:

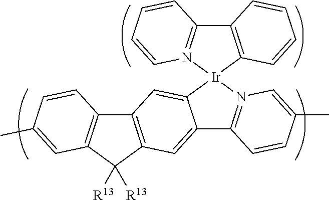

Preferably, the repeat unit of formula (I) is a repeat unit of formula (Ia):

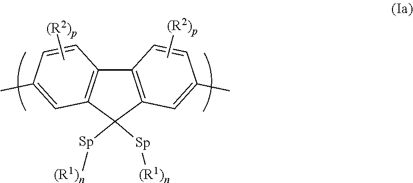

wherein R², p, Sp, R¹ and n are independently in each occurrence as described in relation to the repeat unit of formula (I). Preferably, n in each occurrence is 2.

Preferably p in each occurrence is 0.

An exemplary repeat unit of formula (1a) is:

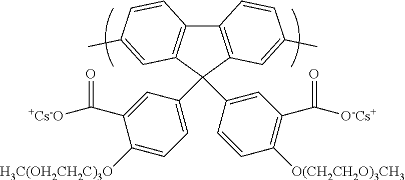

Optionally, the silica polymer comprises repeat units of formula IIa and/or IIb:

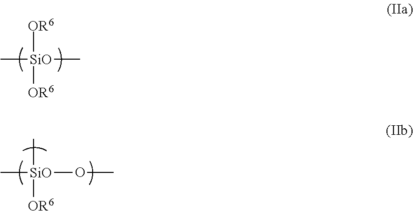

wherein R⁶ in each occurrence is independently selected from H or C₁₋₁₂hydrocarbyl, optionally H or C₁₋₁₂ alkyl. Optionally, the silica polymer further comprises repeat units of formula (IIc):

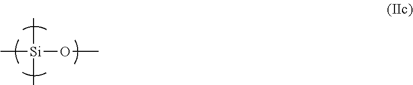

It will be appreciated that the Si atom of the repeat unit of formula (II) is bound to an O atom in the polymer backbone or a group of formula OR⁶.

Preferably, at least 0.1 wt % of total weight of the composite particle consists of the light-emitting polymer. Preferably at least 1, 10, 25 or 50 wt % of the total weight of the composite particles consists of the light-emitting polymer.

Preferably at least 50 wt % of the total weight of the composite particles consists of the silica polymer. Preferably at least 60, 70, 80, 90, 95, 98, 99, 99.5, 99.9 wt % of the total weight of the composite particles consists of silica polymer.

In one embodiment of the first aspect of the invention, at least 70 wt % of the total weight of the composite particles consists of the light-emitting polymer and silica polymer. Preferably at least 80, 90, 95, 98, 99, 99.5, 99.9 wt % of the total weight of the composite particles consists of the light-emitting polymer and silica. More preferably the composite particles essentially consist of the light-emitting polymer and silica polymer.

In one embodiment of the first aspect of the invention, the composite particles are nanoparticulate. Preferably, the nanoparticles have a number average diameter of no more than 5000 nm, more preferably no more than 2500 nm, 1000 nm, 900 nm, 800 nm, 700 nm, 600 mn, 500 nm or 400 nm as measured by a Malvern Zetasizer Nano ZS. Preferably the nanoparticles comprises particles with a number average diameter of between 5-5000 nm, optionally 10-1000 nm, preferably 25-600 nm, more preferably between 50-500 nm, most preferably between 75-400 nm as measured by a Malvern Zetasizer Nano ZS.

The composite particles may be provided as a colloidal suspension comprising the composite particles suspended in a liquid. Preferably, the liquid is selected from water, C₁₋₁₀ alcohols and mixtures thereof. Preferably, the colloidal suspension does not comprise a surfactant.

The composite particles are fluorescent or phosphorescent. Preferably the composite particles are fluorescent. Preferably the composite particles are for use as a fluorescent probe, more preferably for use as a fluorescent probe in an immunoassay such as a lateral flow or solid state immunoassay. Optionally the composite particles are for use in fluorescence microscopy or flow cytometry.

According to the third aspect of the invention, the composite particles of any embodiment of the first aspect of the invention may be formed by polymerisation of a silica monomer in the presence of the light emitting polymer.

In one embodiment, the process comprises treating a solution of silica monomer and light emitting polymer with a base, or by adding a solution of silica monomer to a solution of the light-emitting polymer and a base, wherein the solvents of the solutions are water, one or more C₁₋₁₀ alcohols or a combination thereof.

In another embodiment, the process comprises polymerising silica monomer in a solution of the monomer and light emitting polymer under acidic conditions.

It will be appreciated that the mixture of the silica polymer and light-emitting polymer of the composite particles so formed may or may not be homogeneous and may include, without limitation, one or more chains of light-emitting polymer encapsulated within the particle and/or one or more chains extending through a particle.

The polar groups of the light-emitting polymer may enhance solubility of the polymer in polar solvents and may prevent the polymer from assuming a tightly coiled formation as compared to the case where a light-emitting polymer in which the polar groups are absent is placed in a polar solvent.

The composite particle may be formed from the light-emitting polymer and the silica monomer in a one-step process of polymerisation of the silica monomer in the presence of the light-emitting polymer.

Optionally, the silica monomer is an alkoxysilane, preferably a trialkoxy or tetra-alkoxysilane, optionally a C₁₋₁₂ trialkoxy or tetra-alkoxysilane, for example tetraethyl orthosilicate. The silica monomer may be substituted only with alkoxy groups or may be substituted with one or more groups. In one embodiment, the silica monomer is substituted with a polyether group. In another embodiment, the silica monomer is substituted with a reactive binding group, as described in more detail below, which does not react during polymerisation of the silica monomer or which is protected during polymerisation of the silica monomer.

Optionally, the solution comprises or consists of an ionic solvent or a protic solvent, preferably a solvent selected from water, alcohols and mixtures thereof. Exemplary alcohols include, without limitation, methanol, ethanol, 1-propanol, isopropanol, 1-butanol, 2-butanol, t-butanol and mixtures thereof. Preferably the solution comprises or consists of an alcoholic solvent selected from methanol, ethanol, isopropanol or mixtures thereof, more preferably the solution comprises or consists of a solvent selected from methanol, ethanol or mixtures thereof. Preferably, the solvent system does not comprise a non-alcoholic solvent other than water.

In one embodiment of the third aspect of the invention, the base is an aqueous base preferably, a solution of a hydroxide such as a metal hydroxide, preferably alkali metal hydroxide, ammonium hydroxide or tetraalkylammonium hydroxide in water, preferably 10-40% w/w NH₃ in water, preferably 20-30% w/w NH₃ in water.

In one embodiment of the third aspect of the invention, the light emitting polymer:silica monomer weight ratio is in the range 1:1 to 1:500, preferably 1:3 to 1:300, or 1:5 to 1:200, most preferably 1:10 to 1:100. The present inventors have found that the diameter of the particles can be tuned by selection of the light-emitting polymer:silica weight ratio.

In one embodiment of the third aspect of the invention, the concentration of the light emitting polymer in the solution is at least 0.0005 mg/ml, preferably at least 0.001, 0.01, 0.1, 1 or 10 mg/ml at 25° C.

Optionally, the process of forming the composite particles comprises the steps of:

(a) dissolving the light-emitting polymer in a solvent system selected from one or more protic solvents, optionally water, alcohols and combinations thereof;

(b) adding a base to the solution obtained in step (a); and

(c) adding a solution of silica monomer to the solution of step (b).

Optionally, the process is conducted in a homogeneous solution.

The composite particles may be isolated following formation and resuspended in an aqueous solvent, an organic solvent or a mixture thereof. The composite particles may be isolated from the reaction mixture by centrifuging.

Silica at the surface of the composite particles may be reacted to covalently bind a receptor to the surface of the silica. The receptor may be directly bound to the silica surface or spaced apart therefrom.

A chain binding the receptor to the silica surface preferably comprises or consists of a colloid stabilising group that enhances stability of a colloid comprising the composite particles in a protic liquid such as water or an alcohol in which one or more solutes may be dissolved. The liquid may be a buffer solution.
In one embodiment, the receptor is covalently bound to the composite nanoparticle in a process comprising the steps of:forming a first reactive group RG1 at a surface of the silica;
reacting the reactive group with a compound comprising a second reactive group RG2 capable of reacting with the first reactive group to form a covalent bond and a third reactive group RG3; and
reacting the third reactive group RG3 with the receptor to covalently bind the receptor to the composite nanoparticle

Silica at the surface of the composite particles may be reacted with an organosilane substituted with reactive binding group BG1, optionally an organosilane of formula (X):

(R⁷O)₃Si-Sp¹-RG1 (X)

wherein R⁷ is H or a substituent, preferably a C₁₋₁₀ alkyl group;

Sp¹ is a spacer group; and
RG1 is a first reactive group.

Optionally, RG1 is selected from the group consisting of:

amines, preferably —N(R⁸)₂ wherein R8 in each occurrence is H or a substituent, preferably H or a C1-5 alkyl, more preferably H;

carboxylic acid or an ester thereof, optionally N-hydroxysuccinimide ester;

alkene; alkyne; SH; or azide.

An exemplary organosilane is 3-aminopropyl triethoxysilane.

The reactive binding group BG1 is reacted with a compound of formula (XI)

RG2-Sp2-RG3 (XI)

wherein RG2 is a group capable of reacting with RG1 to form a covalent bond; Sp2 is a spacer group; and RG3 is a reactive binding group capable of binding to a receptor.

Optionally, RG1 is an amine and RG2 is a group capable of reacting with the amine, optionally a group capable of reacting with the amine to form an amide, optionally a carboxylic acid or acid chloride.

Sp1 and Sp2 may each be selected according to their colloid stabilising properties.

The present inventors have found that an polyether chain spacer group at the surface of a silica particle may stabilise collids comprising the particles, particularly in aqueous buffer solution liquids, such as aqeous buffers having a salt concentration greater than 10 mM.

By “polyether chain” as used herein is meant a divalent chain comprising at least two ether groups.

Optionally, Sp¹ and Sp2 are each independently selected from a linear or branched divalent alkylene chain wherein one or more non-adjacent C atoms may be replaced with O, S, C(═O), C(═O)O, C(═O)NR¹² or NR¹², wherein R12 in each occurence is independently selected from H and C1-12 hydrocarbyl, optionally C1-12 alkyl.

Preferably, at least one of Sp1 and Sp2 comprises or consists of a repeating unit of formula (XI):

—((CR¹⁴R¹⁵)_{b}O)_{c}— (XI)

wherein R¹⁴ and R¹⁵ are each independently H or C₁₋₆ alkyl and b is at least 1, optionally 1-5, preferably 2, and c is at least 2, optionally 2-1,000, preferably 10-500, 10-200 or 10-100. The group of formula (XI) may be polydisperse. The group of formula (XI) may have a Mn of at least 500, optionally at least 2,000

Preferably, at least one of Sp¹ and Sp² comprises or consists of a polyethyleneglycol chain.

Optionally, one of groups Sp¹ and Sp² has a chain length of 1-10 atoms, optionally a C₁₋₁₀ alkylene chain, and the other of Sp¹ and Sp² comprises a repeating unit of formula (XI).

The binding group BG3 may be reacted with a receptor which may be synthetic group or a receptor including, without limitation, biological material, optionally peptides, carbohydrates, antibodies, antigens, enzymes, proteins, cell receptors, DNA, RNA, PNA, aptamers and natural products; biologically derived material, optionally recombinant antibodies, engineered proteins; and biomimics, optionally synthetic receptors, biomimetic catalysts, combinatorial ligands and imprinted polymers. A preferred bioreceptor is streptavidin.

It will be appreciated that other methods may be used to covalently bind a receptor and/or a colloid stabilising group to the surface of a silica particle including, without limitation, polymerising a silica monomer that is substituted with a colloid stabilising group and/or an unprotected or protected reactive group RG1; and reacting the composite particle with a compound of formula (R⁷O)₃Si-Sp¹-RG3 wherein Sp1 io comprises a colloid stabilising group.

In use the particle having receptor groups at the surface thereof may bind to target biomolecules in a sample. Biomolecules include without limitation DNA, RNA, peptides, carbohydrates, antibodies, antigens, enzymes, proteins and hormones. A preferred biomolecule is biotin.

The sample may be immobilised on a surface which is brought into contact with the composite nanoparticles described herein, preferably treated with a colloidal suspension comprising the composite nanoparticles described herein.

The polystyrene-equivalent number-average molecular weight (Mn) measured by gel permeation chromatography of the light-emitting polymers or the silica polymers described herein may be in the range of about 1×10³ to 1×10⁸, and preferably 1×10⁴ to 5×10⁶. The polystyrene-equivalent weight-average molecular weight (Mw) of the polymers described herein may be 1×10³ to 1×10⁸, and preferably 1×10⁴ to 1×10⁷.

Polymers as described herein are suitably amorphous polymers.

Composite particles as described herein may be used in, without limitation, biological imaging fluorescence microscopy, flow cytometry and fluorescence-based immunoassays.

### EXAMPLE 1

Method for Forming Blue-Emitting Silica-LEP Composite Nanoparticles via the Stober Process:

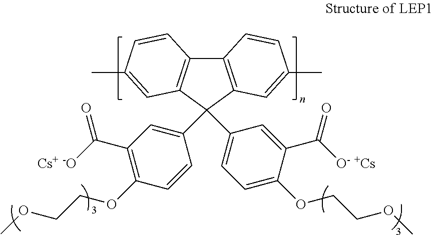

LEP1, disclosed in WO 2012/133229, the contents of which are incorporated herein by reference, was dissolved in methanol (either 1 mg/mL or 10 mg/mL) by heating to 60° C. for 1 hour and the solution was then cooled to room temperature. To 2 mL of this solution was added 0.15 mL of ammonium hydroxide (30% aq.), followed by rapid addition of a solution comprised of tetraethylorthosilicate (TEOS, 0.2 mL) and methanol (0.5 mL), with stirring at room temperature. Stirring was continued for 1 h at room temperature, after which time the solution was centrifuged at 14,000 rpm for 10 minutes to isolate the resultant silica-LEP nanoparticles from the supernatant containing excess unreacted TEOS and ammonium hydroxide. The supernatant was removed by decantation and gentle sonication was used to redisperse the isolated pellet of nanoparticles in 2.5 mL of fresh methanol. Wash cycles consisting of centrifugation, decantation and redispersion in methanol (2.5 mL) were repeated a further two times, followed by three similar washes using 2.5 mL of deionised water. Finally, the nanoparticles were redispersed in 1.5 mL of deionised water for measurement of particle size via dynamic light scattering using a Malvern Zetasizer Nano ZS.

The solid content of the as-prepared nanoparticle suspension (mass of nanoparticles/volume) was determined by isolating the solid nanoparticles from 1 mL of the dispersion by centrifugation at 14,000 rpm for 10 minutes. After washing twice with methanol by centrifugation, decantation and redispersion (as above) and leaving the solid pellet to dry overnight, the mass of solid was determined using a microbalance.

The optical density of the as-prepared nanoparticle dispersion was determined using a Cary 5000 UV-vis-IR spectrometer.

A Hamamatsu C9920-02 PL quantum yield spectrometer equipped with integrating sphere accessory was used to determine the photoluminescence quantum yield of the nanoparticles in aqueous dispersion.

TABLE 1
PLQY of silica-LEP nanoparticles prepared
with varying ratios of LEP1 and TEOS

| | Number | Solid content | |
|---|---|---|---|
| | average | of as-prepared | |
| LEP/TEOS | diameter | dispersion | PLQY |
| ratio | (nm) | (mg/mL) | (%) |
| 1:100 | 75 | 3.7 | 29 |
| 1:10 | 409 | 13.5 | 36 |

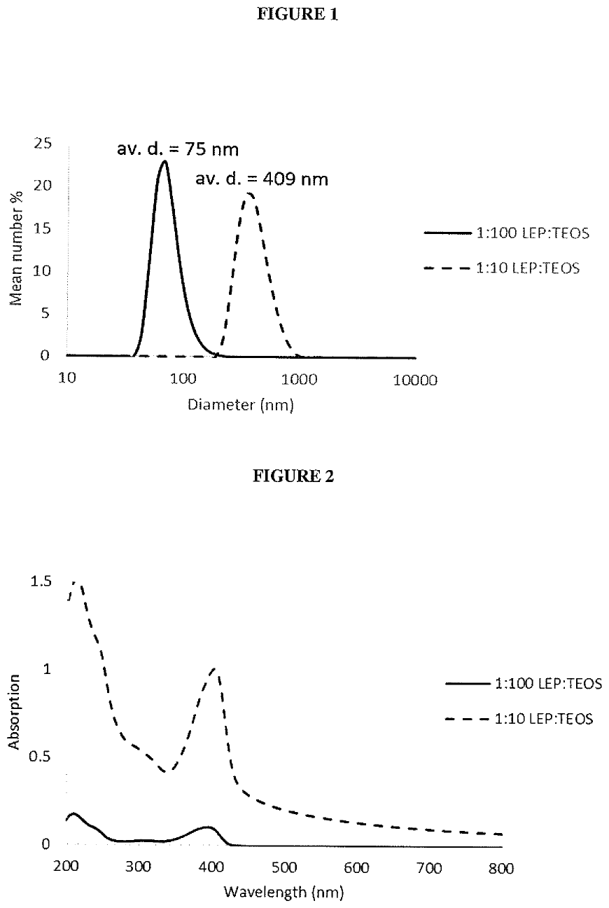

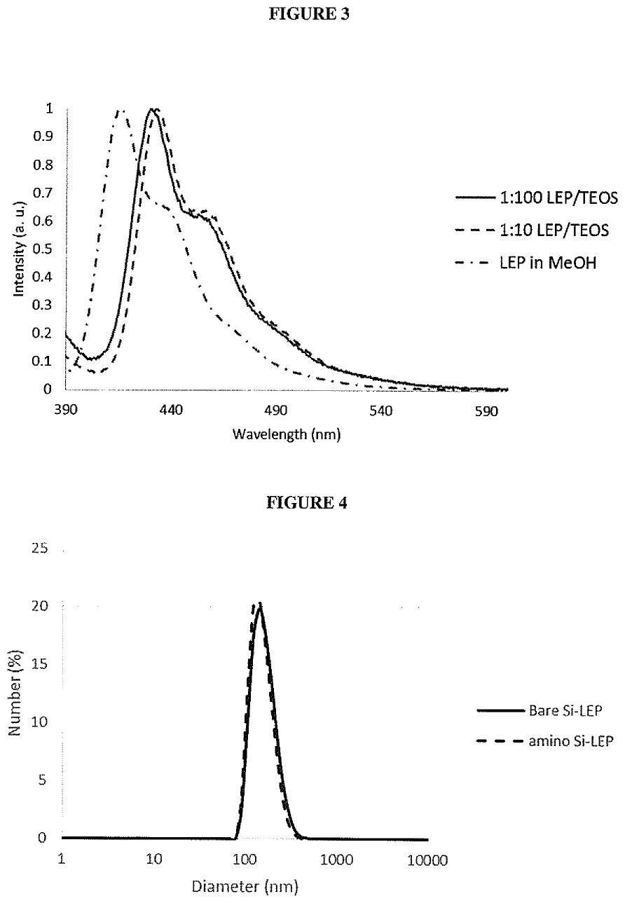

The size distribution, absorption spectra and photoluminescence spectra of these composite particles are shown in FIGS. 1-3.

Due to their very high fluorescence brightness, stability in aqueous buffers and ease of surface attachment to biomolecules, the silica-LEP nanoparticles prepared are particularly well suited for use as fluorescent tracers or tags for optical sensing assays.

Amino Modification of Composite Nanoparticles

To a 3 mL suspension of composite nanoparticles in methanol (number average diameter by dynamic light scattering=165 nm, solid content ˜4 mg/mL) was added 120 uL of (3-aminopropyl)triethoxysilane and the suspension was stirred at room temperature for 1 hour. The suspension was centrifuged at 14,000 rpm for 2 minutes to isolate the resultant silica-LEP nanoparticles from the supernatant containing excess unreacted (3-aminopropyl)triethoxysilane. The supernatant was removed by decantation and gentle sonication was used to redisperse the isolated pellet of nanoparticles in 3 mL of fresh methanol. Wash cycles consisting of centrifugation, decantation and redispersion in methanol (3 mL) were repeated a further two times, before finally redispersing in 3 mL methanol. To prepare samples for dynamic light scattering analysis, 100 uL of the suspension was centrifuged and the supernatant decanted as above and the isolated nanoparticles were resuspended in 1 mL of either methanol or water.

PEGylation of Amino-Modified Composite Nanoparticles

1 mL of the suspension of amino-modified composite nanoparticles in methanol formed in the example above was centrifuged at 14, 000 rpm for 2 minutes to isolate the nanoparticles through decantation of the supernatant. A 1 mL solution of α,ω-Bis{2-[(3-carboxy-1-oxopropyl)amino]ethyl}polyethylene glycol (Mr=2000 g/mol, 10 mg), N-(3-aminopropyl)-N-ethylcarbodiimide (2.1 mg) and N-hydroxysuccinimide (2.5 mg) in methanol was used to redisperse the nanoparticle pellet by gentle sonication and the resultant suspension was stirred at room temperature for 1 hour. The suspension was centrifuged at 14,000 rpm for 2 minutes to isolate the resultant silica-LEP nanoparticles from the supernatant containing excess unreacted PEGylation reagents. The supernatant was removed by decantation and gentle sonication was used to redisperse the isolated pellet of nanoparticles in 1 mL of fresh methanol. Wash cycles consisting of centrifugation, decantation and redispersion in methanol (1 mL) were repeated a further two times. Before the final centrifugation and decantation, the suspension was aliquoted into four 250 uL portions and the resultant pellets were stored at −20° C. prior to use.

Conjugation of Streptavidin to PEGylated Composite Nanoparticles

One of the isolated PEGylated composite nanoparticle pellets in the example above was resuspended in 1 mL of phosphate buffered saline (pH 7.4) by gentle sonication, followed by immediate addition of 50 uL of a solution of streptavidin in the same buffer (1 mg/mL). The suspension was stirred at room temperature for 1 hour before adding to the top of a 4.5 cm height, 3 cm diameter column packed with Sephacryl S-300 HR separation media (prewashed with 150 mL of phosphate buffered saline). The column was eluted with the same buffer collecting 1.5 mL fractions. The column fraction containing the highest concentration of nanoparticles (based on fluorescence intensity) was selected for use in a subsequent bio-assay.

Assessing the Colloidal Stability of Composite Nanoparticles in Various Dispersants

The following test was used to determine the relative stability of bare and functionalised composite nanoparticle (produced from the same batch) in various dispersants.

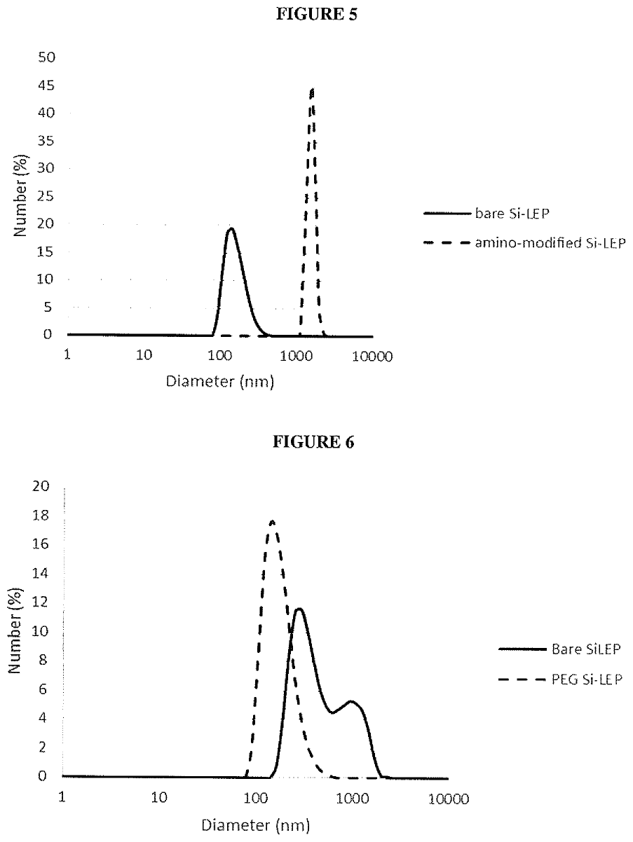

Following centrifugation and decantation, isolated composite nanoparticles (˜0.4 mg) were redispersed in the dispersant (1 mL) by sonication in a bath sonicator for 5 minutes. Immediately prior to DLS analysis the nanoparticle suspension was sonicated for a further minute and was then analysed using a Malvern Zetasizer Nano ZS. Table 2 shows the polydispersity index (PdI) of bare and surface modified composite nanoparticles in various dispersants, as determined by DLS and FIGS. 4-6 show the corresponding number average size distributions.

TABLE 2

| | | | PdI |
|---|---|---|---|
| Composite | | | phosphate |
| particle surface | PdI | PdI in | buffered saline |
| modification | methanol | water | (pH 7.4) |
| None (“bare” | 0.083 | 0.155 | 0.409 |
| particle) | | | |
| amino | 0.060 | 0.474 | — |
| PEG-COOH | — | — | 0.131 |
| (Mr 2000) | | | |

Preparing Biotin-BSA Modified Glass Slides for Bio-Assay

A glass microscope slide funetionalised with a self-assembled monolayer of (3-aminopropyl)silane was submersed in a solution containing succinic anhydride (1 g) and trimethylamine (1.3 mL) in acetonitrile (50 mL) for 16 hours, before washing three times with fresh acetonitrile (50 mL). After drying, a Grace-Biolabs Secure Seal imaging spacer was affixed to the surface of the resultant carboxy-functionalised glass slide in order to isolate four circular areas (diameter =9 mm) for use in the subsequent binding assay. Within each isolated area of the slide was added 80 uL of a 1 mL solution containing N-(3-aminopropyl)-N-ethylcarbodiimide (77.0 mg) and N-hydroxylsulfosuccinimide (33.0 mg). After leaving at room temperature for 30 mins, the solutions were removed and isolated areas washed three times with water (80 uL). After removing the last wash solution, to two of the areas was added 80 uL of a solution of biotinylated bovine serum albumin (50 ug/mL) in phosphate buffered saline (pH 7.4)and to the two remaining areas was added 80 uL of a blocking buffer containing bovine serum albumin (3 wt. %) in phosphate buffered saline (pH 7.4) containing 0.01 wt. % Tween-20. After 1 hour at room temperature, solutions were removed from the two areas containing biotinylated bovine serum albumin solutions and in their place was added 80 uL of the blocking buffer described above. After a further hour at room temperature, solutions were removed from all four areas and each was washed three times with phosphate buffered saline (pH 7.4) containing 0.01 wt. % Tween-20.

Biotin-Binding Assay using Streptavidin-Modified Composite Nanoparticles

To each of the bovine serum albumin modified areas produced in the example above (two biotinylated and two non-biotinylated) was added 60 uL of the column fraction containing streptavidin-modified composite nanoparticles described in the previous example. After leaving for 1 hour at room temperature, the solution was removed and washed three times with 80 uL of phosphate buffered saline (pH 7.4) containing 0.01 wt. % Tween-20 and once with 80 uL of deionised water. After allowing to dry in air, the fluorescence intensity of each of the four assay regions was measured using a microscope-based spectrometer, using a mercury lamp as the excitation source (λex=365 nm) and a fibre-optic spectrometer for detection. As shown in figure X, the average integrated fluorescence intensity of the two assays containing biotin is higher than that for the non-biotinylated control regions, demonstrating that Si-LEP nanoparticles have been immobilised on the surface through specific streptavidin-biotin interactions.

### EXAMPLE 2

A green-emitting silica-LEP composite particle was obtained by following the same Stöber procedure as Example 1 utilising LEP2 as the conjugated polymer.

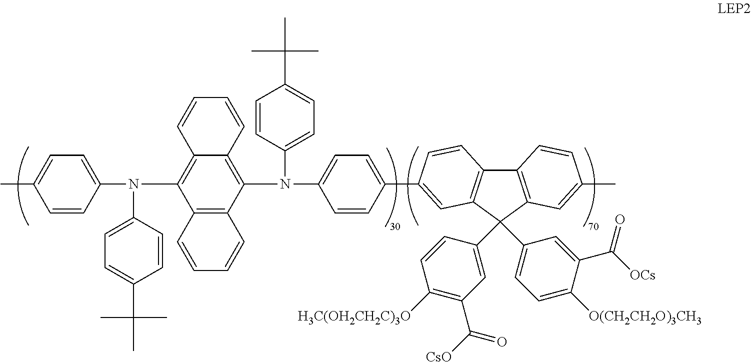

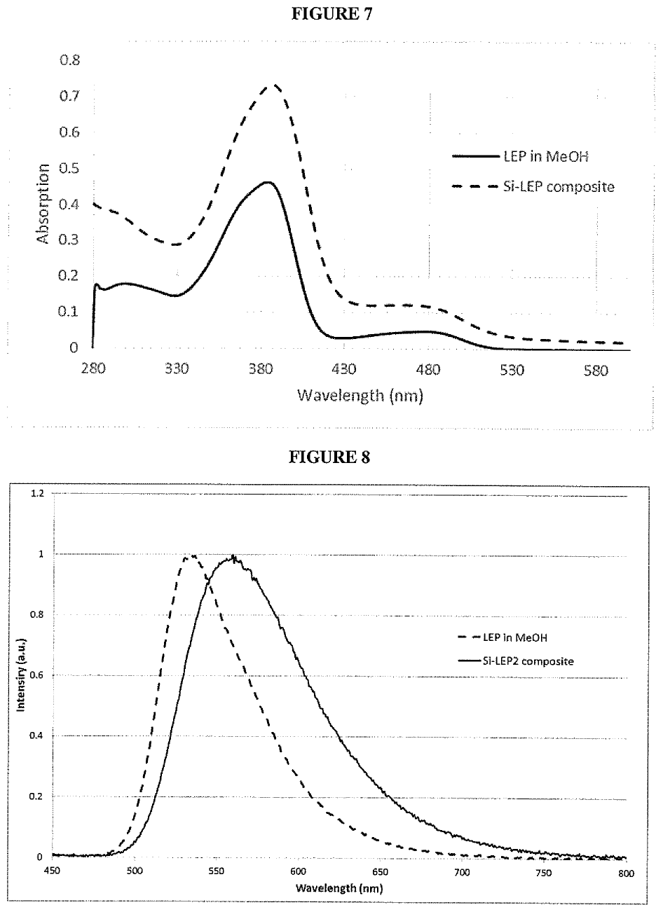

The UV absorption and photoluminescence spectra for these nanoparticles are shown in FIGS. 7 and 8 respectively.

The photoluminescence quantum yield (PLQY) of the silica-LEP2 composite nanoparticles was found to be 46%.

The particles have the following dimensions:

Z average—195.5 nm

Number average—137.0 nm

Intensity average—225.5 nm

The particles have a PDI of 0.131.

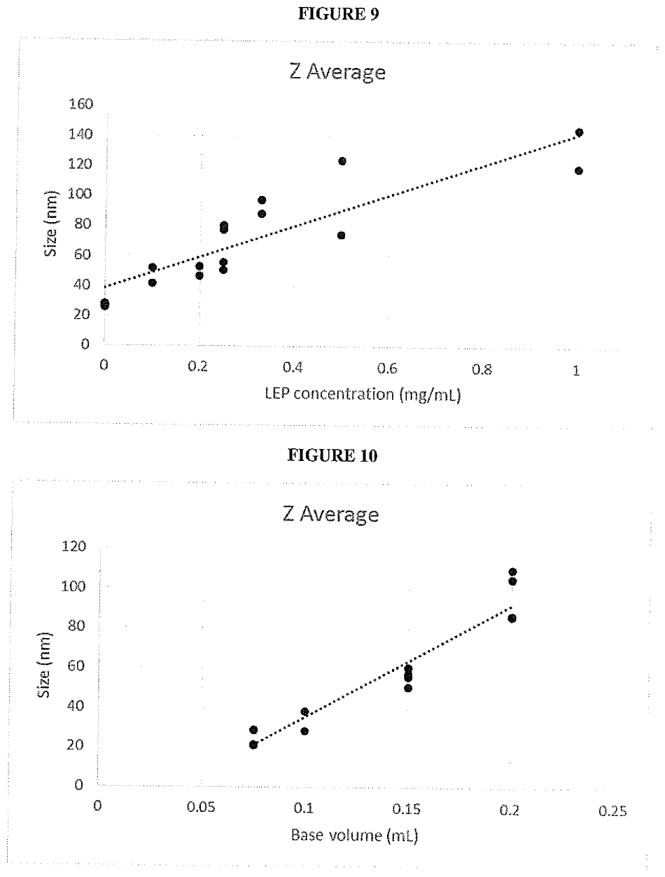

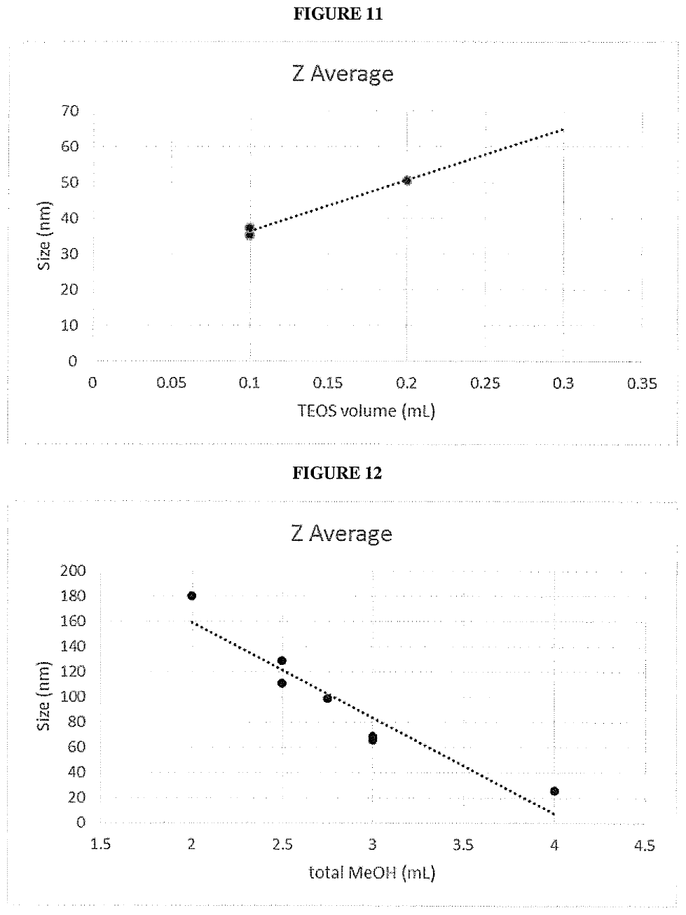

The size of the composite nanoparticles can be controlled by altering the concentration of conjugated polymer, silicate volume, base volume and/or overall dilution, as shown in FIGS. 9-12 respectively in which the Z-average diameter is measured by dynamic light scattering.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A composite particle comprising a mixture of a silica polymer and a light-emitting polymer comprising a backbone and polar groups pendant from the backbone.

2. The composite particle according to claim 0, wherein the light-emitting polymer has a solubility of at least 0.001 mg/ml in an alcoholic solvent.

3. The composite particle according to claim 0, wherein the polar groups comprise or consist of groups of formula —O(R³O)_{q}—R⁴ wherein R³ in each occurrence is a C₁₋₁₀ alkylene group wherein one or more non-adjacent C atoms may be replaced with O, R⁴ is H or C₁₋₅ alkyl and q is at least 1.

4. The composite particle according to claim 1, wherein the polar groups comprise or consist of ionic groups.

5. The composite particle according to claim 4, wherein the ionic groups are —COO⁻ groups.

6. The composite particle according to claim 1 wherein the light-emitting polymer is a conjugated polymer.

7. The composite particle according to claim 6 wherein the backbone of the light-emitting polymer comprises repeat units of formula (I): 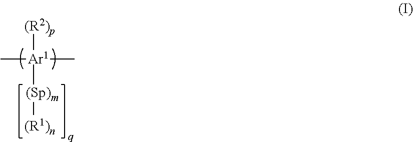
wherein Ar¹ is an arylene group; Sp is a spacer group; m is 0 or 1; R¹ is a polar group; n is 1 if m is 0 and n is at least 1 if m is 1; R² is a non-polar substituent; p is 0 or a positive integer; q is at least 1; and wherein Sp, R¹ and R² may independently in each occurrence be the same or different.

8. The composite particle according to claim 7 wherein the repeat unit of formula (I) is a repeat unit of formula (Ia): 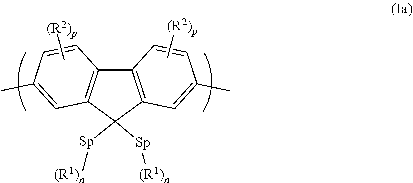
wherein R², p, Sp, R¹ and n are independently in each occurrence.

9. The composite particle according to claim 1, wherein the silica polymer comprises repeat units of formula IIa and/or IIb: 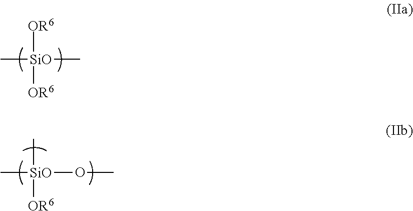
wherein R⁶ in each occurrence is independently selected from H or C₁₋₁₂hydrocarbyl.

10. The composite particle according to claim 9, wherein the silica polymer further comprises repeat units of formula IIc:

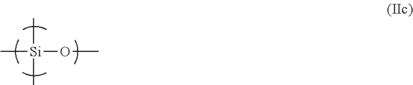

11. The composite particle according to, claim 1 wherein the composite particle is nanoparticulate.

12. The composite particle according to, claim 1 wherein the composite particle is fluorescent.

13. The composite particle according to, claim 1, comprising a receptor group for binding to a biomolecule covalently bound to the surface of the silica polymer.

14. The composite particle according to claim 1 wherein a polyether chain is covalently bound to the surface of the silica polymer.

15. The composite particle according to claim 13 wherein the polyether chain is provided between the surface of the silica polymer and the receptor.

16. A colloidal suspension comprising composite particles according to claim 1 suspended in a liquid.

17. A colloidal suspension according to claim 16 wherein the liquid is a protic liquid.

18. A colloidal suspension according to claim 17 wherein the protic liquid comprises one or more salts dissolved therein.

19. A process for preparing composite particles according to claim 1, comprising formation of the silica polymer by polymerisation of a silica monomer in the presence of the light emitting polymer.

20. A process according to claim 19 wherein the silica monomer, dissolved in a solvent, is polymerised in the presence of a base.

21.-28. (canceled)
